(19) United States
(12) Patent Application Publication
(10) Pub. No.: US 2012/0034103 A1
(43) Pub. Date: Feb. 9, 2012

(54) METHOD AND APPARATUS FOR MONITORING OF ESP

(76) Inventors: Andrey Bartenev, Moscow (RU); Vladimir Danov, Erlangen (DE); Bernd Gromoll, Baiersdorf (DE); Stepan Polikhov, Ramenskoe (RU); Evgeny Sviridov, Moscow (RU)

(21) Appl. No.: 13/138,433

(22) PCT Filed: Feb. 13, 2009
(86) PCT No.: PCT/RU2009/000069

§ 371 Date: Oct. 24, 2011

(30) Foreign Application Priority Data
Apr. 20, 2009 (US) 61/170919

(51) Int. Cl. F04B 49/00; G01H 5/00; F04B 35/04

(52) U.S. Cl. 417/1; 417/410.1; 73/645

(57) ABSTRACT

A method monitors an ESP with a pump for pumping oil, gas, water or other fluid media, which pump is driven by an electrical motor. Acoustical phenomena of the motor and/or the pump are used as a state variable for pumping the media. The acoustic phenomena are measured as electrical signals and the electrical signals are discriminated in respect to the pumped media. In the corresponding apparatus for monitoring of ESP, with pump section(s) for pumping a mixture of oil, gas and water, which is driven by a motor section(s), whereby at least one acoustic sensor is placed near the ESP.

### CROSS REFERENCE TO RELATED APPLICATIONS

This application is based on and hereby claims priority to International Application No. PCT/RU2009/000069 filed on Feb. 13, 2009, the contents of which are hereby incorporated by reference.

### BACKGROUND

The invention is directed to a method and apparatus for monitoring an ESP.

Oil has to be pumped from underground reservoirs in onshore industry and under water in offshore industry. At most a multiphase flow of oil and gas and eventually water is existent. Therefore electrical submersible pumps (ESP) are needed.

A safe monitoring of the ESP is important. Such monitoring systems must detect gas content in the well liquid flow in order to shut down the pump if too high gas content in the well liquid occurs to prevent damage of the pump.

Downhole monitoring systems are available. There are the following publications which provide technical background:

“Boletin Quincenial”, Aug. 31, 1997, describes a multiphase flowmeter suitable for well testing especially with a pump system. WO 2006/115931 A2 describes a multiphase flowmeter and a data system with different units outside the borehole. EP 0 684 458 A2 describes a multiphase flowmeter for measuring the flow rate of multiphase fluids such as oilwell effluents, containing liquid hydrocarbons, gas and water, which is based on differential pressure measurements. EP 1 022 429 A1 describes a multi purpose riser which is inside the oil-pipeline. The US 2005/0268702 A1 describes a non intrusive multiphase flowmeter whereby two physical parameters of the flow are measured for determining the density of the mixture. The U.S. Pat. No. 4,604,902 A describes techniques useful in mass-flowmeters for multiphase flows.

Further WO 02/044664 A1 describes a multiphase flowmeter using multiple pressure differentials for signal generation. Especially the WO 2007/114707 A2 describes an acoustic multiphase meter, which includes an ultrasound emitter and an ultrasound receiver for the response signals.

All monitoring or measuring systems described in the preceding documents are working on one of the three phenomena and/or principles for multiphase flow measurements. These are:

1) measuring of pressure drop and correlation of pressure drop with the flow void fraction.

2) using radioactive source or ultrasonic source to measure the velocity and the flow void fraction and

3) semi online measurement separating the different phases of the multiphase flow.

The apparatuses known by the preceding state or art are quite complicated.

### SUMMARY

Therefore it is one possible object to find other phenomena for monitoring ESP. It is a further possible object to create an apparatus for the method which is cost efficient and could be integrated in existing systems.

The inventors propose a monitoring system, which allows controlling the pumps—if needed—to shut the pumps down, for example if too high gas content in the well liquid occurs. This is realized by at least one acoustic detector which is placed on a pump intake (see FIG. 1 of the Detailed Description).

Depending on the gas void fraction in the well liquid the detector delivers different signals which are significant for the pumped fluid media and the different phases of the fluid media. In this way one can identify the gas fraction in the well liquid and thus control the pump.

This monitoring system can be made also in combination with other measuring systems for instance double wall tube for phase separation, pressure drop, pH-evaluation and/or composition measuring system.

One innovative step is the use of acoustic sensors for pump monitoring and measurement of the gas content in the well liquid. There is no active sound emitter like disclosed in WO 2007/114707 A2, but the use of the impact sound with an acoustic sensor. This is advantageous in view of the technical complexity and also in view of joined costs.

Such monitoring systems may have different shape, assembling and might be placed on different positions.

In any case the gas fraction in the media flow is identified. This is designated from the gas void fraction in the well liquid.

The pump may be controlled by identifying the gas fraction in the well liquid. By delivering different control signals from the detector the pump will be stopped when the gas fraction in the well liquid is exceeding a given threshold.

Using the method with the new monitoring system can prevent damage of pumps caused by a too high gas content in the well liquid.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 a projection of a facility for well liquid pumping with a bore hole (well) and the pump components and

FIG. 2 a system with hard- and software components for evaluating the measurements.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

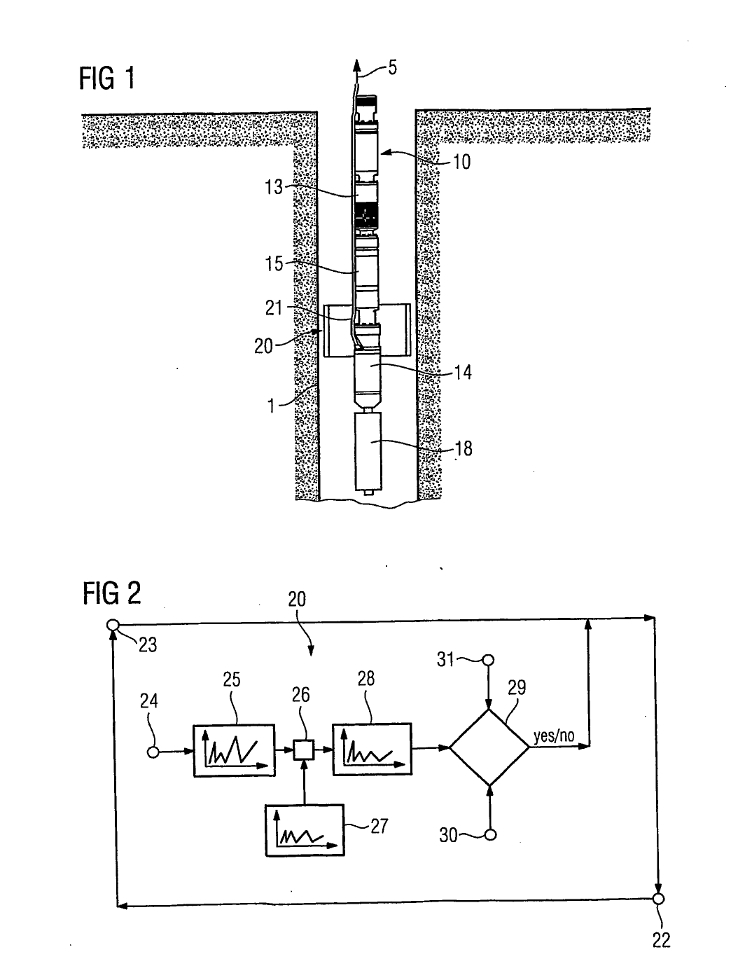

In FIG. 1 a bore hole is shown in cross section and characterized with numeral 1. The bore hole 1 has the depth of some thousand meters, for example 3,000m from the ground of earth, and a diameter of for example 4″ (inches). The bore hole 1 leads from a below ground oil reservoir (not shown) and is quite narrow in view of length. The bore hole 1 can be also situated under water from the sea bottom to the reservoir. The fluid conveyed from the reservoir to ground is normally a mixture of oil, gas and water. In FIG. 1 numeral 5 characterized such a multiphase mixture flow.

In the bore hole 1 there is installed a so called ESP 11 (electrical submersible pump).The ESP 11 can have some pump sections 10 for pumping the well liquid from the well to surface. Also ESP has a pump intake 13 and can include a gas separator.

The ESP 11 has a motor section(s) with an electrical motor 14. The motor 14 of the ESP 11 has a motor protector 15. Such a motor protector is known in the art.

There could be also an own monitoring system 18 for the ESP 11. This is also known in the art.

Further there is at least an acoustic sensor 21 which is joined to the motor 14 and/or placed on the pump section 10. The acoustic sensor 21 is part of an acoustic monitoring system 20 with hard- and software-components shown in FIG. 2. These hard- and software-components can control the pump system 10 and especially stop the pump motor 14 preventing damages.

There could be more than one acoustic sensor, which are all part of a sensor system 20 with a monitoring unit for evaluating which are shown in FIG. 2.

The evaluating system has to be suitable for discriminating signals based on oil pumping from signals based on gas pumping or based on gas voids. Also signals based on pumping of water should be discriminated from signals based on pumping of oil.

In FIG. 2 the components 22 to 31 form the acoustic monitoring system of FIG. 1: There is a first input 22 of a line for data transfer from the pump control system to the pump monitoring system 18. Additionally there is a second input 23 of a line for data transfer from the pump monitoring system 18 to the pump control system.

There is an input 24 for an acoustic signal based on the acoustic sensor 21 and acoustic sensor system 20 of FIG. 1. The acoustic signals are dependant on fluid properties, for example the properties of two-phase flow and/or three phase flow, which is shown in unit 25, which is followed by a correction unit 26 for signal offset correction.

In the correction unit 26 the acoustic signal offset which is shown in unit 27 is subtracted. This means that the noise from the motor, from bearings and other mechanical parts will be eliminated. The resulting signal without offset is shown in unit 28.

In accordance to the measurements and the evaluation shown in unit 28 the ESP 11 of FIG. 1 could be controlled automatically whereby a decision unit 29 is followed.

Further to the self-acting control specific requirements of the customer can be incorporated in the described system via data inputs 30, 31 for the decision unit 29.

Other signals for monitoring the state variables, for example pressure drop, pH-evaluation and/or composition measuring system could be combined with the acoustic monitoring system.

In any case there are defined correlations between the fluid properties, especially of oil, gas and water mixture flow, and the acoustic signal. A stop of the ESP 11 can be triggered if necessary. It will be actuated in situations especially when the gas fraction in the well liquid is exceeding a given threshold, because of the danger of undesirable damages in the whole oil conveying facility.

In accordance with the figures a method had been described for monitoring ESP for producing oil, gas, water or other fluid media, which pump is driven by an electrical motor, acoustical phenomena of the motor and/or the pump are used as state variable for pumping the media. The acoustic phenomena are measured as electrical signals and the electrical signals are discriminated in respect to the pumped media. In the apparatus for monitoring of ESP, with a pump for pumping a mixture of oil, gas and water, the pump is driven by a motor. At least one acoustic sensor is placed in the near of the pump system and/or pump motor.

The invention has been described in detail with particular reference to preferred embodiments thereof and examples, but it will be understood that variations and modifications can be, effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A method for monitoring an electronic submersible pump (ESP) having a pump section for pumping fluid media, the method comprising:
monitoring acoustical phenomena of an electrical motor used to drive the pump section;
converting the acoustical phenomena into electrical signals; and
using the acoustical phenomena of the motor as a state variable to identify the media being pumped, by discriminating electrical signals with respect to different pumped media.

17. The method of claim 16, whereby the electrical signals are discriminated to differentiate between oil, gas and water.

18. The method of claim 17, whereby after discrimination, the electrical signals for oil, gas and water are saved separately.

19. The method of claim 16, whereby the acoustical phenomena of the motor is used to identify a gas fraction in the media being pumped.

20. The method of claim 19, whereby the pump section is used to pump fluid media from a well, and the gas fraction in the media is used to identify a gas/liquid fraction in the well.

21. The method of claim 20, further comprising controlling the pump section based on the gas/liquid fraction in the well.

22. The method of claim 16, whereby
a detector is used to monitor acoustical phenomena of the electrical motor, and
the pump section is controlled based on different signals delivered from the detector.

23. The method of claim 20, whereby the pump section is stopped when the gas/liquid fraction in the well exceeds a defined threshold.

24. The method of claim 16, whereby
the media being pumped is also monitored with a second system, and
the second system relies on at least one of a radioactive source, an ultrasonic source, pressure drop, pH and composition measurements.

25. The method of claim 16, further comprising producing an online measurement result that separately identifies the different media being pumped.

26. An electronic submersible pump (ESP), comprising:
a pump section for pumping a mixture comprising oil and gas from a well;
an electrical motor to drive the pump section;
an acoustic sensor placed in the well near the electrical motor and/or the pump section, the acoustic sensor converting acoustical phenomena into electrical signals; and
a monitoring unit to use the acoustical phenomena of the motor as a state variable to identify the media being pumped, by discriminating electrical signals with respect to different pumped media.

27. The apparatus of claim 26, whereby the acoustic sensor is placed down the well, under a pump intake.

28. The apparatus of claim 27, whereby the acoustic sensor is placed near the motor.

29. The apparatus of claim 28, whereby
the motor includes a motor protector, and
the acoustic sensor is placed on the motor protector.

30. The apparatus of claim 26, further comprising:
a second monitoring system to monitor the media being pumped, the second monitoring system relying upon at least one of a radioactive source, an ultrasonic source, pressure drop, pH and composition measurements.
